(19) United States
(12) Patent Application Publication
(10) Pub. No.: US 2009/0279134 A1
(43) Pub. Date: Nov. 12, 2009

(54) Data Transmitting Apparatus, Data Transmitting Method, and Recording Medium Capable of Transmitting Image Data to Specific Destination by Simple Operation

(75) Inventor: Masato FUJII, Nagaokakyo-shi (JP)

Correspondence Address: BUCHANAN, INGERSOLL & ROONEY PC, POST OFFICE BOX 1404, ALEXANDRIA, VA, 22313-1404, US

(73) Assignee: KONICA MINOLTA BUSINESS TECHNOLOGIES, INC., Tokyo (JP)

(21) Appl. No.: 12/436,198

(22) Filed: May 6, 2009

(30) Foreign Application Priority Data
May 9, 2008 (JP) JP 2008-123622

(51) Int. Cl. G06F 3/12; H04N 1/04

(52) U.S. Cl. 358/1.15; 358/474

(57) ABSTRACT

A destination input screen is displayed, and it is determined whether a start button is depressed. If the start button is depressed, it is determined whether a destination is already input on the destination input screen. If the destination is input on the destination input screen before the start button is depressed, the input destination is set. A scan and transmission processing is executed. If the destination is not input on the destination input screen when the start button is depressed, a registered destination is set to the destination.

This application is based on Japanese Patent Application No. 2008-123622 filed with the Japan Patent Office on May 9, 2008, the entire content of which is hereby incorporated by reference.

### BACKGROUND OF THE INVENTION

1. Field of the Invention

The present invention relates to a data transmitting apparatus, a data transmitting method, and a recording medium for transmitting image data obtained by scanning an original document (hereinafter referred to as an “original”).

2. Description of the Related Art

There is conventionally known an MFP (Multi Function Peripheral) including an address function capable of registering a plurality of user addresses, and configured so that the addresses registered in an address book are displayed on an operation screen and a destination is selected from among the addresses if data transmission or the like is to be executed.

The address function is not limited to a function of the address book stored in a storage unit in the MFP in advance Alternatively, an address book stored in a specific server connected to the MFP via the Internet can be referred to. A technique capable of, if a server storing therein address book data on each user and a certain user changes an address of the user, automatically changing address book data on the certain user is disclosed in, for example, Japanese Laid-Open Patent Publication No. 2003-108479. With this technique, the address book can be referred to by accessing the server.

Meanwhile, in case of the conventional MFP, if data transmission or the like is to be executed and many addresses that are user destinations are registered, all the addresses cannot be displayed on the display screen. Due to this, it is disadvantageously required to search a desired address by screen scrawling or screen switching.

Generally, as a method of transmitting data using the MFP, image data obtained by scanning an original by a scanner is transmitted to a computer or the like of a user by an E-mail or the like, and the user views or edits the image data on the computer of the user or transfers the image data to another user.

For the user using the computer as stated above, such an MFP as to be able to set the address of the user himself or herself as the destination of data transmission quickly with simple operation is desired. However, operation for searching the address book and selecting the destination that is the address of the user himself or herself is disadvantageously cumbersome.

To solve the problem, a technique for automatically setting an address of a user himself or herself as a destination when a user authentication is performed and the user logs in is disclosed in Japanese Laid-Open Patent Publication No. 2006-011985.

However, the technique disclosed in the Japanese Laid-Open Patent Publication No. 2006-011985 has the following problems. If data transmission of transmitting image data or the like to a destination other than the address of the user himself or herself is to be executed, then it is necessary to temporarily delete the user address automatically set as the destination and to input an address of a destination other than the user since the user address is always automatically set as the destination. This makes it necessary to perform cumbersome operation.

Furthermore, since the automatically set content (address) is displayed on a destination input screen as the destination, it is necessary to perform cumbersome operation for confirming whether the destination indicates the address of the user himself or herself

### SUMMARY OF THE INVENTION

The present invention has been made to solve the conventional problems. It is an object of the present invention to provide a data transmitting apparatus, a data transmitting method, and a recording medium capable of transmitting image data to a specific destination by simple operation.

A data transmitting apparatus according to an aspect of the present invention is a data transmitting apparatus comprising: an image reader for scanning an original document to obtain image data; an operation unit including an input key for inputting a destination of the image data and a predetermined key for providing an instruction to start an operation of the image reader, and a data transmitter for transmitting the image data obtained by the image reader to the destination according to operation of the predetermined key in a predetermined mode, wherein the data transmitter transmits the image data to a predetermined destination when the predetermined key is operated before the destination is input during the predetermined mode.

Preferably, the data transmitting apparatus according to the aspect of the present invention further includes: a user authentication unit authenticating an input user as a specific user according to input of predetermined data by the operation unit; and a data storage unit storing therein address data including the predetermined destination associated with the input user authenticated by the user authentication unit.

In particular, at least one of the user authentication unit and the data storage unit is connected to an external apparatus over a network.

Preferably, the data storage unit further stores therein read setting information associated with the input user for defining an operation performed by the image reader.

Preferably, the data transmitting apparatus according to the aspect of the present invention further includes a display unit displaying the destination input by the input key A situation that the predetermined key is operated before the destination is input corresponds to a situation that a display content of the display unit is blank.

In particular, the display unit displays the predetermined destination if the operation unit operates the predetermined key.

Preferably, the predetermined destination is a transfer apparatus connected to the data transmitting apparatus over a network, and the image data is transmitted to another predetermined destination connected to the data transmitting apparatus via the transfer apparatus over the network.

A data transmitting method according to another aspect of the present invention is a data transmitting method for a data transmitting apparatus including an image reader for scanning an original document to obtain image data, an input key for inputting a destination of the image data and an predetermined key, comprising the steps of: operating the predetermined key for providing an instruction to start an operation of the image reader in a predetermined mode, and transmitting the image data obtained by the image reader according to operation of the predetermined key, the step of transmitting including i) determining whether the destination is already input during the predetermined mode at the time of the operation of the predetermined key, and ii) transmitting the image data to the destination if the destination is already input and to a predetermined destination if the destination is not yet input.

Preferably, the data transmitting method according to another aspect of the present invention further includes the steps of authenticating an input user as a specific user according to input of predetermined data; and obtaining address data including the predetermined destination associated with the authenticated input user.

Particularly in the step of obtaining, read setting information associated with the input user for defining an operation performed by the image reader is further obtained.

Preferably, the data transmitting method according to another aspect of the present invention further includes the step of displaying the input destination. A situation that the destination is not yet input during the predetermined mode at the time of the operation of the predetermined key corresponds to a situation that a display content of the display unit is blank in the step of displaying.

Particularly, in the step of displaying, the predetermined destination is displayed if the predetermined key is operated.

Preferably, the predetermined destination is a transfer apparatus connected to the data transmitting apparatus over a network, and the image data is transmitted to another predetermined destination connected to the data transmitting apparatus via the transfer apparatus over the network.

A recording medium according to yet another aspect of the present invention is a recording medium recording a program for executing a data transmitting method in a data transmitting apparatus including an image reader for scanning an original document to obtain image data, an input key for inputting a destination of the image data and an predetermined key, comprising the steps of operating the predetermined key for providing an instruction to start an operation of the image reader in a predetermined mode; and transmitting the image data obtained by the image reader according to operation of the predetermined key, the step of transmitting including i) determining whether the destination is already input during the predetermined mode at the time of the operation of the predetermined key, and ii) transmitting the image data to the destination if the destination is already input and to a predetermined destination if the destination is not yet input.

Preferably, the recording medium according to yet another aspect of the present invention further causes the program to execute the steps of authenticating an input user as a specific user according to input of predetermined data; and obtaining address data including the predetermined destination associated with the authenticated input user.

Particularly in the step of obtaining, read setting information associated with the input user for defining an operation performed by the image reader is further obtained.

Preferably, the recording medium according to yet another aspect of the present invention further causes the program to execute the step of displaying the input destination. A situation that the destination is not yet input during the predetermined mode at the time of the operation of the predetermined key corresponds to a situation that a display content of the display unit is blank in the step of displaying.

Particularly in the step of displaying, the predetermined destination is displayed if the predetermined key is operated.

Preferably, the predetermined destination is a transfer apparatus connected to the data transmitting apparatus over a network. Preferably, the image data is transmitted to another predetermined destination connected to the data transmitting apparatus via the transfer apparatus over the network.

With the data transmitting apparatus, the data transmitting method, and the recording medium according to the present invention, if the image data obtained by the image reader is to be transmitted to the destination input by the input key according to the operation of the predetermined key, the image data is transmitted to the predetermined destination when the destination is not input and the predetermined key is operated. Therefore, even if the destination is not input, it is possible to easily transmit the image data to the specific destination.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic block diagram describing an overall configuration of a data transmitting system according to an embodiment of the present invention.

FIG. 2 is a schematic block diagram describing a configuration of an MFP according to the embodiment of the present invention.

FIG. 3 is a schematic diagram describing an operation panel of the MFP described in FIG. 2.

FIG. 4 is a schematic diagram describing a display state of a display unit if a scan key is depressed.

FIG. 5 is a block diagram describing a schematic configuration of a personal computer according to the embodiment of the present invention.

FIG. 6 is a flowchart describing a user authentication processing according to the embodiment of the present invention.

FIG. 7 is a schematic diagram describing an authentication screen according to the embodiment of the present invention.

FIG. 8 is a schematic diagram describing my address data obtained from an address server.

FIG. 9 is a flowchart describing a data transmitting method according to the embodiment of the present invention.

FIG. 10 is a schematic diagram describing a reception screen if image data is transmitted to an address registered as a registered destination according to a flow of FIG. 9.

FIG. 11 is a flowchart describing a data transmitting method according to a modification of the embodiment of the present invention.

### DESCRIPTION OF THE PREFERRED EMBODIMENTS

Referring to the accompanying drawings, embodiments of the present invention will be described hereinafter. In the drawings, same components or constituent elements are denoted by same reference symbols and are assumed to be identical in names and functions, respectively.

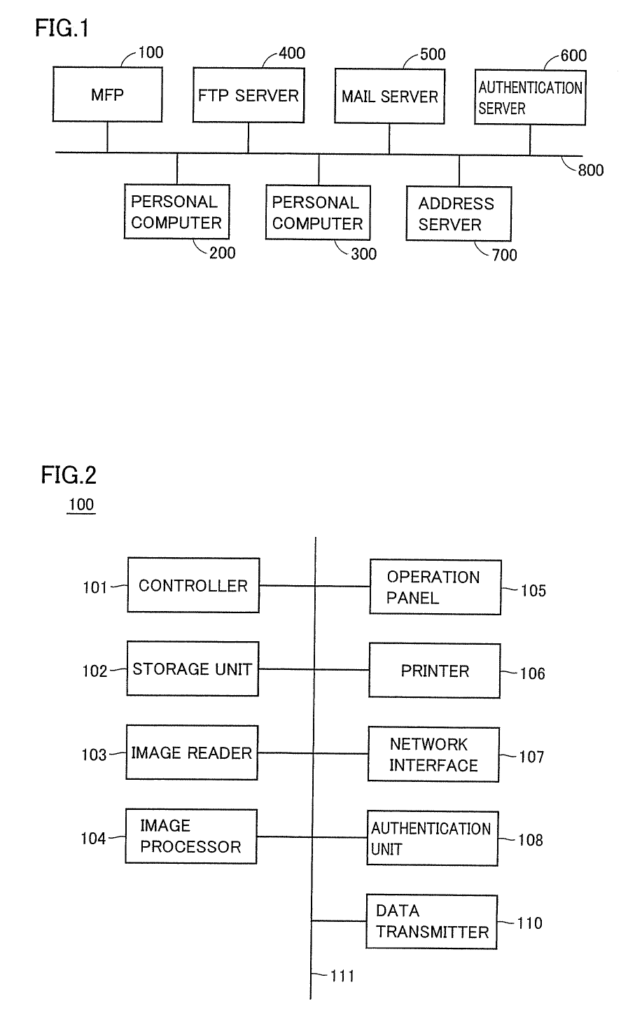

Referring to FIG. 1, an overall configuration of a data transmitting system according to an embodiment of the present invention will be described.

Referring to FIG. 1, the data transmitting system according to the embodiment of the present invention includes an MFP 100 including functions as a data transmitting apparatus, personal computers 200 and 300, an FTP (File Transfer Protocol) server 400, a mail server 500, an authentication server 600, and an address server 700. The constituent elements 100 to 700 of the data transmitting system are communicably connected to one another over a network 800.

Examples of network 800 include a local area network (LAN) connecting computers or network devices to one another according to a standard such as the Ethernet, a token ring or FDDI (Fiber-Distributed Data Interface) standard, a wide area network (WAN) connecting LANs to one another by a dedicated line, and the Internet. It is to be noted that types and the number of devices connected to network 800 are not limited to those described above.

Referring to FIG. 2, a configuration of MFP 100 according to the embodiment of the present invention will be described.

Referring to FIG. 2, MFP 100 according to the embodiment of the present invention includes a controller 101, a storage unit 102, an image reader 103, an image processor 104, an operation panel 105, a printer 106, a network interface 107, an authentication unit 108, and a data transmitter 110. The constituent elements 101 to 110 of the MFP 100 are communicably connected to one another by a bus 111.

Controller 101 is a CPU (Central Processing Unit) and executes controls over the other constituent elements of MFP 100, various arithmetic operations and the like according to programs stored in storage unit 102.

Storage unit 102 is constituted by, for example, a ROM (Read Only Memory), a RAM (Random Access Memory) or a hard disk. Storage unit 102 is used as an operating region for executing the programs or as a region for storing image data or the like obtained by an image processing performed by image processor 104

It is assumed that the programs stored in storage unit 102 include a client program for using a communication service such as that of mail server 500 or the like.

It is assumed that storage unit 102 stores therein address book data capable of referring to an E-mail address or the like set as a destination of data transmission to be described later as the address book.

Image reader 103 includes a light receiving element such as a CCD (Charge Coupled Device) for photoelectrically converting a reflected light of a light emitted from a light source and irradiated on an original into an electric signal, and an automatic original feeder feeding the original to a predetermined read position. Image reader 103 obtains image data on the original from the light receiving element such as the CCD.

Image processor 104 executes format conversion or the like for converting a format of the image data into a format suited for data transmission.

Operation panel 105 includes a touch panel used to display various information and to input various commands, ten keys for setting the number of copies and the like, a start key for instructing start of an operation, a stop key for instructing stop of an operation, a reset key for initializing various setting conditions, and the like. A configuration of operation panel 105 will be described later.

Printer 106 prints out various data such as image data obtained by scanning the original using image reader 103 or image data obtained from an external apparatus over network interface 107 on a recording material such as a sheet.

The network interface 107 is an interface for connecting MFP 100 to an external apparatus so as to communicate with the external apparatus on the network.

Authentication unit 108 executes a user authentication processing between MFP 100 and authentication server 600 according to depression of a predetermined key among those on operation panel 105,

Data transmitter 110 transmits the image data obtained by, for example, image reader 103 in response to an instruction from controller 101.

MFP 100 includes not only a copy function but also a scan and transmission function (e.g., Scan to E-Mail or Scan to SMB (Server Message Block)) that is a function of transmitting the image data obtained by scanning the original or the like to the other apparatus such as personal computer 200 over network 800, and a print function of receiving image data from the other apparatus such as personal computer 200 and printing out the image data.

Referring back to FIG. 1, FTP server 400 is a server computer including a file storage function and a file transfer function.

Mail server 500 is a server computer providing a communication service for transmitting or receiving E-mails and using, for example, an SMTP (Simple Mail Transfer Protocol) and a POP (Post Office Protocol).

Authentication server 600 is a server computer providing a service for performing a user authentication processing, that is, authenticating that a user is an identical user permitted to use computer 200 or 300. Authentication server 600 integrally manages each user name and a password associated with each user.

Address server 700 is a server computer managing an address book of each user.

Personal computers 200 and 300 are computers used by specific users (e.g., users A and B), respectively, and can receive E-mail transmitted from MFP 100 via mail server 500. It is assumed that each user can execute operation such as addition or editing of a content of data on the address book of the user (also referred to as “my address data”) by accessing address server 700 from personal computer 200. It is also assumed that each user can perform a setting operation of setting one address among a plurality of addresses included in my address data to a registered destination. It is further assumed that each user can change the registered destination. Moreover, each user can obtain my address data from address server 700 if it is necessary to do so.

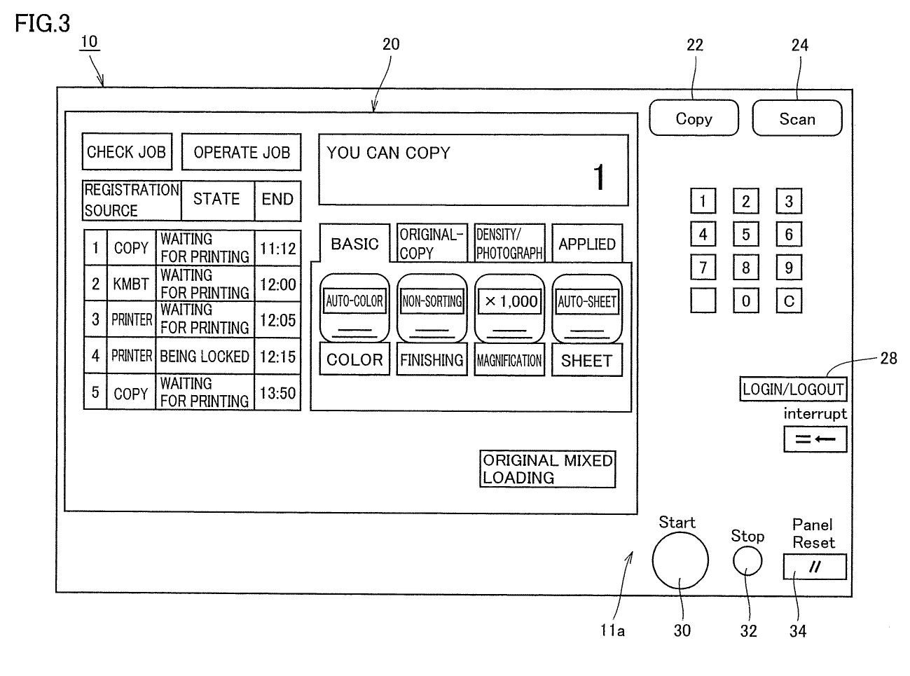

Referring to FIG. 3, operation panel 105 of MFP 100 described with reference to FIG. 2 will be described.

FIG. 3 shows a console 10 of operation panel 105 of MFP 100. A key operation unit 11a and a display unit 20 are provided on console 10.

A start key 30 provided on key operation unit 11a is used to start operation such as a copy operation or a scan operation. Ten keys that are number keys are used to input a numeric value such as the number of copies. A stop key 32 is used to instruct stop of the copy or scan operation. A panel reset key 34 is used to cancel a set mode and a set job.

Display unit 20 displays various modes. The touch panel is attached onto a surface of display unit 20.

The user can execute various settings according to display contents of display unit 20 using the touch panel. For example, if a setting screen for setting a user name (user ID (identification)) or the like that is user identification information necessary for the user authentication processing is displayed on display unit 20 by executing a predetermined operation, the user can set the user ID or the like using the various keys on key operation unit 11a or a touch button or the like displayed on display unit 20. It is assumed that, if the user sets the user ID or the like, the user ID or the like is registered in authentication server 600 and that the user authentication processing can be performed between MFP 100 and authentication server 600 using authentication unit 108. While an instance of setting the user ID or the like on MFP 100 side has been described, authentication data for executing the user authentication processing can be registered by directly accessing authentication server 600 from personal computer 200 or 300

If the user operates MFP 100, then a login screen is displayed by depressing a login/logout button 28 and the user authentication processing can be executed by inputting the registered user ID or the like.

Buttons for basic/applied settings normally made if the copy operation or the scan operation is executed are also arranged on display unit 20. By depressing each of the buttons, a hierarchical screen or the like for making detailed settings is displayed.

A copy key 22 and a scan key 24 provided on key operation unit 11a are selection keys for making a setting as to whether MFP 100 operates in a copy mode or a scan mode.

If copy key 22 is depressed, MFP 100 can be used as a copier. In this state, the scan operation cannot be executed.

At this time, various settings for the copy operation are displayed on display unit 20. After finishing the settings, the copy operation starts by setting the original and depressing start key 30.

If scan key 24 is depressed, MFP 100 can be used as a scanner. In this state, the copy operation cannot be executed.

At this time, various settings for the scan operation are displayed on display unit 20. After finishing the settings, the scan operation starts by setting the original and depressing start key 30.

It is to be noted that copy key 22 and scan key 24 correspond to exclusive operations, that is, if one of copy key 22 and scan key 24 is selected, the other key is automatically deselected.

FIG. 3 shows an example of a display state of display unit 20 if copy key 22 is depressed.

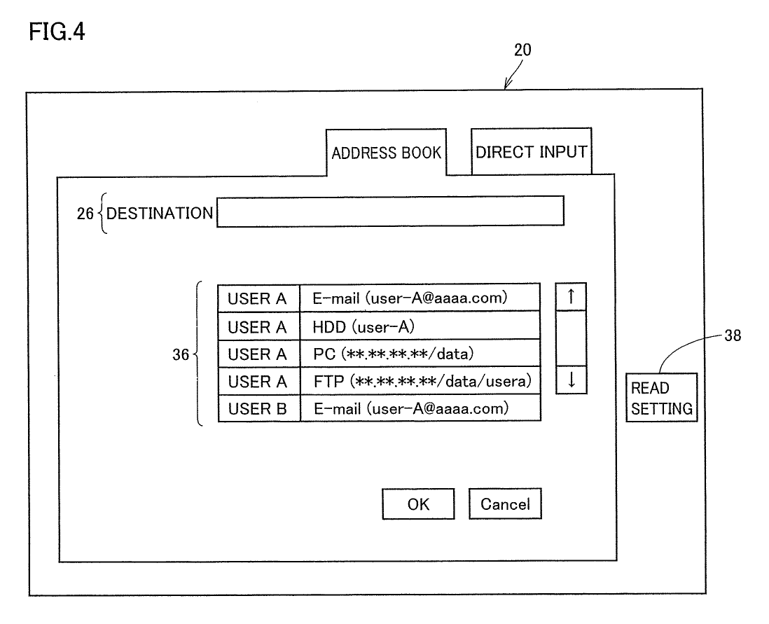

Referring to FIG. 4, a display state of display unit 20 if scan key 24 is depressed will be described.

Referring to FIG. 4, if scan key 24 is depressed, a destination input screen is displayed on display unit 20. Specifically, a box 26 for inputting the destination (hereinafter, also “destination input box 26”) if the original is scanned is displayed on display unit 20.

Furthermore, an instance of selecting one address book is shown in the example of FIG. 4, and a group of address selection candidates 36 to be input to box 26 for inputting the destination is displayed on display unit 20. By user's selecting one address from among group of address selection candidates 36, the selected address can be input to destination input box 26. It is to be noted that the addresses displayed as group of address selection candidates 36 are based on my address data stored in storage unit 102.

If the user selects a “direct input” tab, the user can input a symbol or the like that serves as the address directly to destination input box 26.

It is assumed that detailed settings for scanning the original can be made if the user depresses a read setting button 38. Specifically, it is assumed that a setting of a file format (TIFF (Tagged Image File Format), PDF (Portable Document Format) or the like) of obtained image data (not shown), a setting of a resolution at the time of obtaining the image data, a setting of both-sided or one-sided scanning of the original, a setting of an image quality of the image of the original, a setting of a scan size of the image of the original and the like can be made.

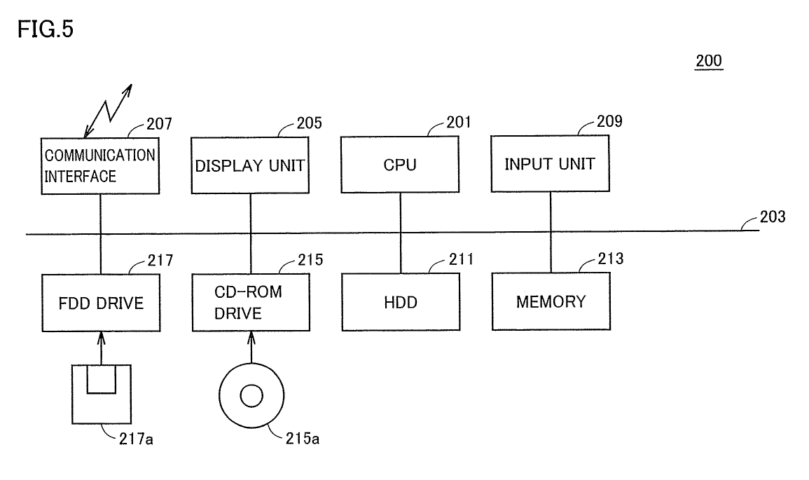

Referring to FIG. 5, a schematic configuration of personal computer 200 or 300 according to the embodiment of the present invention will be described. Since personal computers 200 and 300 are identical in configuration, personal computer 200 will be typically described herein.

Referring to FIG. 5, personal computer 200 according to the embodiment of the present invention includes a CPU (Central Processing Unit) 201 for executing various programs including an operating system (OS), a memory 213 temporarily storing therein data necessary for CPU 201 to execute the programs, and a hard disk drive (HDD) 211 storing therein the programs executed by CPU 201 in a nonvolatile form.

Furthermore, such programs are read by a floppy disk drive 217 or a CD-ROM drive 215 from a flexible disk 217a or a CD-ROM (Compact Disk-Read Only Memory) 215a, respectively

CPU 201 receives a user instruction via an input unit 209 configured to include a keyboard, a mouse and the like, and outputs screens generated by executing the programs to a display unit 205. Further, CPU 201 transmits or receives information to or from another apparatus connected to personal computer 200 by a network via a communication interface 207 configured to include a LAN card or the like. The constituent elements of personal computers 200 mutually transmit or receive data by an internal bus 203.

A data transmission processing according to the embodiment of the present invention will be described.

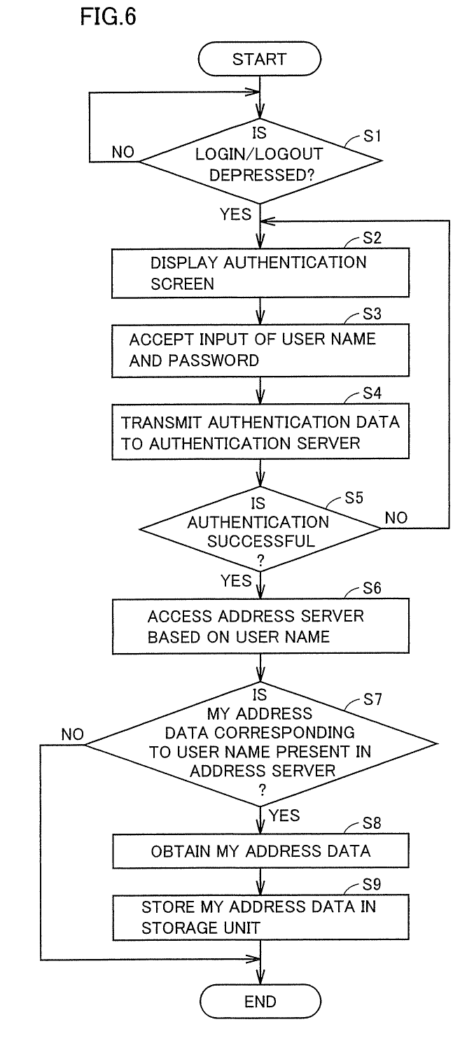

Referring to FIG. 6, the user authentication processing according to the embodiment of the present invention will be described.

Referring to FIG. 6, it is determined whether login/logout button 28 is depressed (step S1).

If it is determined that login/logout button 28 is depressed (step S1; YES), an authentication screen is displayed (step S2).

Specifically, controller 101 detects that login/logout button 28 on operation panel 105 is depressed and instructs authentication unit 108 to execute the user authentication processing.

Authentication unit 108 displays an authentication screen for executing the user authentication processing on display unit 20 of operation panel 105 in response to the instruction from controller 101. It is assumed that a program and the like necessary for displaying the authentication screen on display unit 20 are stored in storage unit 102. The same thing is true for other screens and the like.

On the authentication screen, input of a user name and a password is accepted (step S3).

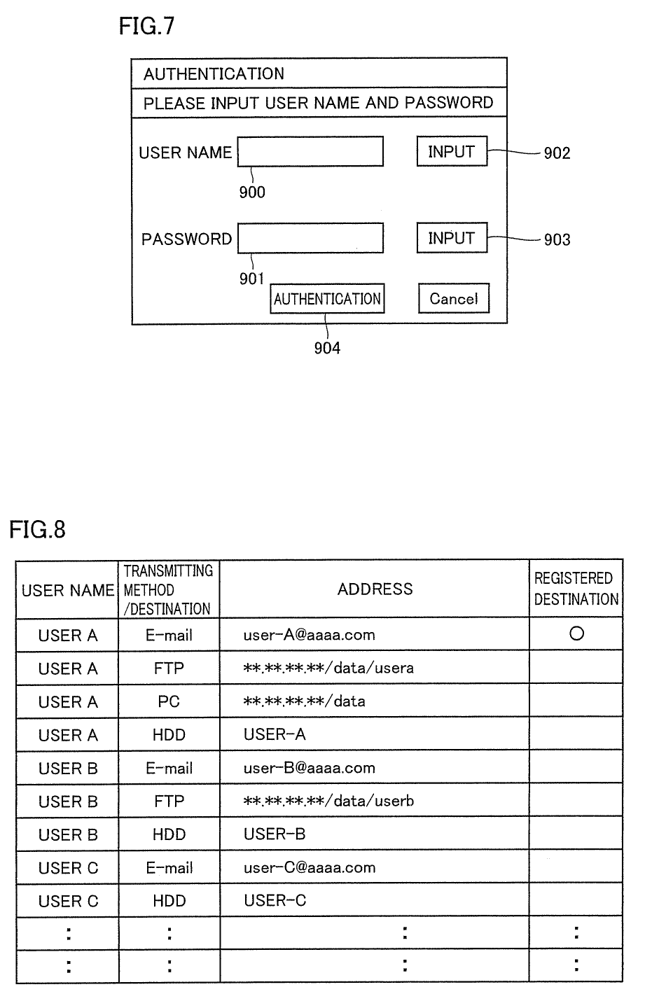

Referring to FIG. 7, the authentication screen according to the embodiment of the present invention will be described.

Referring to FIG. 7, an input screen for inputting the user name and the password is displayed as the authentication screen

Specifically, a user name input box 900 for accepting input of the user name and a password input box 901 for accepting input of the password are displayed on the authentication screen.

The input of the user name and the password is accepted by user's operating character keys (not shown) or the like displayed by depressing input buttons 902 and 903.

Referring back to FIG. 6, by user's depressing an authentication button 904 shown in FIG. 7 after the input is accepted, authentication unit 108 transmits user authentication data including the input user name and password to authentication server 600 (step S4)

It is determined whether authentication server 600 successes in user authentication (step S5).

Specifically, authentication server 600 receives the user authentication data transmitted from authentication unit 108 and determines whether the user is an identical user permitted to use personal computer 200 or 300 based on whether the received user authentication data coincides with authentication data registered in advance

If determining that the user is the identical user permitted to use personal computer 200 or 300 based on the user authentication data, authentication server 600 transmits a notification indicating a user authentication success to authentication unit 108 of MFP 100. If determining that the user is not the identical user permitted to use personal computer 200 or 300 based on the user authentication data, authentication server 600 transmits a notification indicating a user authentication failure to authentication unit 108 of MFP 100

Authentication unit 108 determines whether authentication unit 108 has received the notification indicating the user authentication success from authentication server 600 (step S5).

If authentication unit 108 receives the notification indicating the user authentication failure from authentication server 600 (step S5; NO), then the processing returns to step S2, the authentication screen is displayed again in step S2, and the input of the user name and the password is accepted again in step S3.

If authentication unit 108 receives the notification indicating the user authentication success from authentication server 600 (step S5; YES), authentication unit 108 accesses address server 700 based on the authenticated user name (step S6).

If address book data on the identified user (my address data) corresponding to the user name is present in address server 700 (step S7; YES), authentication unit 108 obtains my address data (step S8). Authentication unit 108 stores obtained my address data in storage unit 102 as the address book of the user (step S9). The processing ends (END). As a consequence, if an “address book” tab is selected on the destination input screen described with reference to FIG. 4, group of address selection candidates 36 is displayed based on my address data stored in storage unit 102. Moreover, an address of a registered destination, to be described later, included in my address data is set.

If it is determined that my address data corresponding to the user name is not present in address server 700 (step S7; NO), the processing ends.

Referring to FIG. 8, my address data obtained from address server 700 will be described.

It is assumed that my address data is stored in address server 700 to correspond to each user name.

FIG. 8 shows my address data on the user A by way of example

Specifically, FIG. 8 shows users A to C as user name having destination addresses, respectively by way of example. Data transmitting method/destination is classified into E-mail, FTP, PC, HDD and the like. Addresses serving as destinations are described in my address data.

In the example shown in FIG. 8, an instance of registering an E-mail address user-A@aaa.com in the transmitting method/destination of the user A as a registered destination is shown.

As already stated, it is assumed that the operation for performing the addition, edition or the like on my address by user's accessing address server 700 via personal computer 200 or 300. It is also assumed that the registered destination can be set or changed.

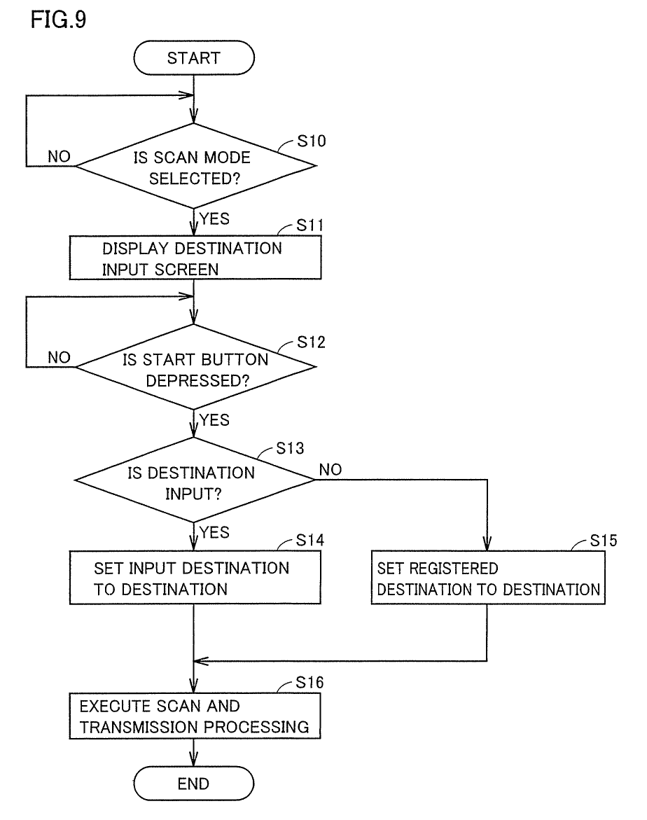

Referring to FIG. 9, the data transmitting method according to the embodiment of the present invention will be described.

Referring to FIG. 9, it is determined whether the scan mode is selected (step S10). If it is determined that the scan mode is selected (step S10, YES), the destination input screen is displayed (step S1). Specifically, controller 101 detects depression of scan key 24 on operation panel 105, and displays the destination input screen shown in FIG. 4 if scan key 24 is depressed. At this moment, destination input box 26 is blank

It is determined whether start button 30 is depressed (step S12).

If it is determined that start button 30 is depressed (step S12; YES), it is determined whether a destination is already input on the destination input screen (step S13).

Specifically, it is determined whether an address is input to destination input box 26 described with reference to FIG. 4 before depression of start button 30.

If it is determined that a destination is input on the destination input screen before depression of start button 30 (step S13, YES), the input destination is set (step S14).

A scan and transmission processing is executed (step S16). Specifically, image reader 103 scans the original set on an original table to thereby obtain the image data, a transmission processing for transmitting the image data to the set destination is performed, and the scan and transmission processing ends (END).

If it is determined that destination input box 26 is blank when start button 30 is depressed, that is, the destination is not input on the destination input screen (S12; NO), the registered destination is set to the destination (step S15). Specifically, the address registered as the registered destination described with reference to FIG. 8 is set to the destination.

The processing proceeds to step S16 in which the same scan and transmission processing as that described above is executed, and the processing ends. If the registered destination is set to the destination, a setting can be made so that the address serving as the destination is displayed on display unit 20 when the scan and transmission processing is executed.

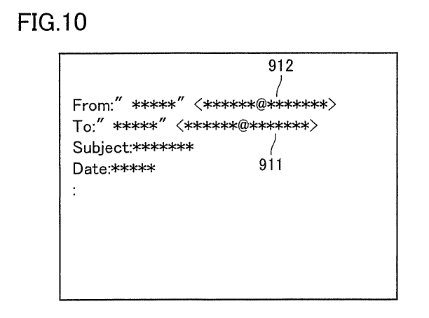

Referring to FIG. 10, a reception screen displayed if the image data is transmitted to the address registered as the registered destination according to the flow of FIG. 9 will be described.

Referring to FIG. 10, a box where From address 912 indicating a transmission source of an E-mail is described and a box where To address 911 indicating a destination of the E-mail is described are arranged on a header of the E-mail, and the user can view the image data attached to the E-mail although the image data is not shown in FIG. 10.

The E-mail address set to From address 912 is displayed as a sender (transmission source) of the E-mail on the personal computer (e.g., personal computer 200 or 300) receiving the E-mail. If the E-mail address set to the destination is an E-mail address of an authenticated user as the registered destination, the E-mail address of the authenticated user is set to To address 911.

An E-mail address of MFP 100 is set to From address 912. If the personal computer receives the E-mail for which such an address is set, the user can grasp that the user transmits the E-mail from MFP 100. Alternatively, an E-mail address of an administrator can be used in place of the E-mail address of MFP 100.

With the transmitting method according to the embodiment of the present invention, the image data obtained by the scanner can be transmitted by operating start key 30.

Specifically, if the destination is not input on the destination input screen, the data can be transmitted to the registered destination.

Therefore, there is no need for the user to search the address book of the user and to select, for example, the destination of the user himself or herself on the destination input screen. Further, since the destination of the user himself or herself is not automatically set and input to the destination input box, there is no need to perform the cumbersome operation of temporarily deleting the address set and input as the destination if image data or the like is to be transmitted to the destination other than the user's own destination.

Moreover, if the destination is not input on the destination input screen, that is, the destination input box is blank, data is transmitted to the destination of the user that is the registered destination Due to this, there is no need to perform an operation for confirming destination information (address). Therefore, the image data can be transmitted to the registered destination with simple operation and destination selection can be simplified during data transmission.

### Modification of Embodiment

In the embodiment stated above, if start button 30 is depressed; it is determined whether the destination is input on the destination input screen. If it is determined that the destination is not input, the image data is transmitted to the registered destination. However, the embodiment is not limited to start button but another input instruction can be used.

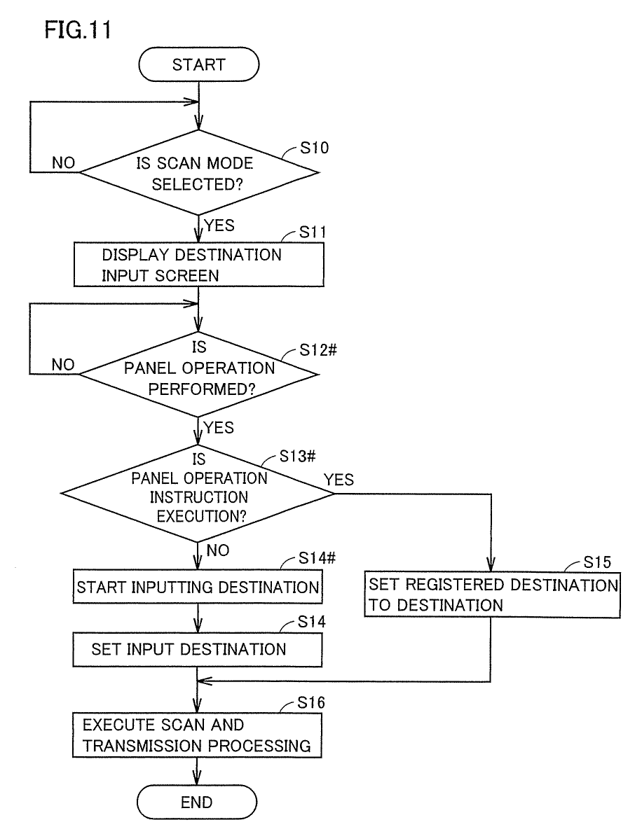

Referring to FIG. 11, a data transmitting method according to a modification of the embodiment of the present invention will be described.

A flowchart of FIG. 11 differs from the flowchart of FIG. 9 in that steps S 12 and S13 are replaced by steps S12# and S13#, respectively and in that step S14# is added. Since the other steps in the flow shown in FIG. 11 are similar to those shown in FIG. 9, they will not be repeatedly described herein.

Specifically, after the destination input screen is displayed in step S11, it is determined whether a panel operation is performed (step S12#). If it is determined that the panel operation is performed (step S12#; YES), it is determined whether the panel operation is an execution instruction (step S13#).

Specifically, it is determined whether an “OK” button is depressed (operated) right after the destination input screen is displayed.

If the “OK” button is depressed right after the destination input screen is displayed (step S13#; YES), the registered destination is set to the destination (step S15) since destination input box 26 is blank, that is, the destination is not input on the destination input screen. Specifically, the address registered as the registered destination described with reference to FIG. 8 is set to the destination.

The scan and transmission processing is executed (step S16).

If the panel operation performed for the first time since the destination input screen is displayed is not depression of the “OK” button that is the execution instruction but operation of the number keys, the character keys (not shown) or the like on key operation unit 11a (step S13#; NO), input of the destination is started (step S14#). An input content is displayed in destination input box 26.

On the destination input screen, the input destination is set (step S14).

Specifically, if the “OK” button indicating the execution instinction is depressed for the content input in destination input box 26, the content is set as the destination on the destination input screen.

The similar scan and transmission processing as that described above is executed (step S16). The processing ends. If the registered destination is set to the destination, a setting can be made so that the address serving as the destination is displayed on display unit 20 when the scan and transmission processing is executed.

Accordingly, a setting of the destination input can be executed with whether the panel operation is the execution instruction used as a trigger.

With the configuration according to each of the embodiment and the modification of the present invention, address server 700 integrally manages the address book data. Therefore, there is no need to create the address books for each MFP and the address book data can be used versatilely.

Moreover, according to the embodiment and the modification of the present invention, the instance that authentication server 600 and address server 700 are provided independently of each other. Alternatively, authentication server 600 can include functions of address server 700 so as to make a setting of transmitting my address data to MFP 100 if the user authentication processing is successful.

Furthermore, not only information such as the destination address and the registered destination but also the read setting information on image reader 103 according to user's preference, that is, the setting information such as the setting of the file format (TIFF, PDF or the like) of the obtained image data, the setting of the resolution at the time of obtaining the image data, the setting of the both-sided or one-sided scanning of the original, the setting of the image quality of the image of the original, and the scan size of the image of the original can be stored in my address data.

By storing the setting information in my address data, it is possible to eliminate cumbersomeness of user's changing detailed settings for scanning the original made in image reader 103 according to user's preference. Specifically, storing of the setting information in my address data can be realized by causing controller 101 to change detailed settings related to the scanning of the original made in image reader 103 from default based on the stored read setting information.

In the embodiment and the modification of the present invention, the instance that MFP 100 set the registered destination as the destination if the destination is not input on the destination input screen, that is, the destination input screen is blank has been described. Alternatively, data indicating that the destination is not input on the destination input screen, that is, the destination input screen is blank can transferred to another apparatus, e.g., a predetermined server connected to the data transmitting system by the network, and the predetermined server can set the registered destination to the destination so as to execute data transmission instead of causing MFP 100 to execute a destination setting processing.

In the embodiment and the modification of the present invention, the instance of the processing for obtaining the address book data using address server 700 and storing the obtained address book data in storage unit 102 of MFP 100 and the like have been described. Alternatively, address book data corresponding to each user name can be stored in storage unit 102 of MFP 100 in advance and such a setting can be made so as to be able to refer to the address book data stored in storage unit 102 in advance if the user authentication is successful by the user authentication processing

In the embodiment and the modification of the present invention, only the instance of setting one address as the registered destination has been described. However, the number of addresses setting as the registered destination is not limited to one but a plurality of addresses can be set as registered destinations. Further, an optimum destination can be automatically selected and set from among a plurality of addresses according to a data amount of the scanned original.

The data transmitting apparatus according to the present invention is not limited to the MFP but may be a facsimile apparatus or the like. A program for causing a computer to function to execute control described with reference to the flows can be provided. Such a program can be provided as a program product by recording the program in a computer readable recording medium such as a flexible disk, a CD-ROM, a ROM, a RAM or a memory card attached to the computer. Alternatively, such a program can be provided by recording the program in a recording medium such as a hard disk included in the computer.

The program according to the present invention may execute each processing by invoking a necessary module out of program modules provided as part of an operating system (OS) of the computer in a predetermined array. In that case, the program does not include the modules per se but the processing is executed in cooperation between the program and the OS. Such a program that does not include modules can be also contained in the program according to the present invention.

Moreover, the program according to the present invention may be provided by incorporating the program in part of the other program. In that case, the program does not include modules included in the other program per se and the processings are executed in cooperation between the program and the other program. Such a program incorporated in the other program can be contained in the program according to the present invention.

The provided program product is executed by being installed in a program storage unit such as a hard disk. It is to be noted that the program product includes the program itself and the recording medium recording therein the program.

Although the present invention has been described and illustrated in detail, it is clearly understood that the same is by way of illustration and example only and is not to be taken by way of limitation, the scope of the present invention being interpreted by the terms of the appended claims.

What is claimed is:

1. A data transmitting apparatus comprising:
an image reader for scanning an original document to obtain image data;
an operation unit including an input key for inputting a destination of said image data and a predetermined key for providing an instruction to start an operation of said image reader; and
a data transmitter for transmitting said image data obtained by said image reader to said destination according to operation of said predetermined key in a predetermined mode,
wherein said data transmitter transmits said image data to a predetermined destination when said predetermined key is operated before said destination is input during said predetermined mode.

2. The data transmitting apparatus according to claim 1, further comprising
a user authentication unit authenticating an input user as a specific user according to input of predetermined data by said operation unit; and
a data storage unit storing therein address data including the predetermined destination associated with the input user authenticated by said user authentication unit.

3. The data transmitting apparatus according to claim 2,
wherein at least one of said user authentication unit and said data storage unit is connected to an external apparatus over a network.

4. The data transmitting apparatus according to claim 2,
wherein said data storage unit further stores therein read setting information associated with said input user for defining an operation performed by said image reader.

5. The data transmitting apparatus according to claim 1, further comprising a display unit displaying the destination input by said input key,
wherein a situation that the predetermined key is operated before the destination is input corresponds to a situation that a display content of said display unit is blank.

6. The data transmitting apparatus according to claim 5,
wherein said display unit displays said predetermined destination if the predetermined key is operated.

7. The data transmitting apparatus according to claim 1,
wherein said predetermined destination is a transfer apparatus connected to the data transmitting apparatus over a network, and
said image data is transmitted to another predetermined destination connected to the data transmitting apparatus via said transfer apparatus over the network.

8. A data transmitting method for a data transmitting apparatus including an image reader for scanning an original document to obtain image data, an input key for inputting a destination of said image data and an predetermined key, comprising the steps of:
operating said predetermined key for providing an instruction to start an operation of said image reader in a predetermined mode; and
transmitting said image data obtained by said image reader according to operation of said predetermined key, said step of transmitting including
i) determining whether the destination is already input during said predetermined mode at the time of said operation of said predetermined key, and
ii) transmitting said image data to said destination if said destination is already input and to a predetermined destination if said destination is not yet input.

9. The data transmitting method according to claim 8, further comprising the steps of:
authenticating an input user as a specific user according to input of predetermined data; and
obtaining address data including the predetermined destination associated with the authenticated input user.

10. The data transmitting method according to claim 9,
wherein in said step of obtaining, read setting information associated with said input user for defining an operation performed by said image reader is further obtained.

11. The data transmitting method according to claim 8, further comprising the step of:
displaying the input destination,
wherein a situation that the destination is not yet input during said predetermined mode at the time of said operation of said predetermined key corresponds to a situation that a display content of said display unit is blank in said step of displaying.

12. The data transmitting method according to claim 11,
wherein in said step of displaying, said predetermined destination is displayed if said predetermined key is operated.

13. The data transmitting method according to claim 8,
wherein said predetermined destination is a transfer apparatus connected to the data transmitting apparatus over a network, and
said image data is transmitted to another predetermined destination connected to the data transmitting apparatus via said transfer apparatus over the network.

14. A recording medium recording a program for executing a data transmitting method in a data transmitting apparatus including an image reader for scanning an original document to obtain image data, an input key for inputting a destination of said image data and an predetermined key, comprising the steps of:
operating said predetermined key for providing an instruction to start an operation of said image reader in a predetermined mode; and
transmitting said image data obtained by said image reader according to operation of said predetermined key, said step of transmitting including
i) determining whether the destination is already input during said predetermined mode at the time of said operation of said predetermined key, and
ii) transmitting said image data to said destination if said destination is already input and to a predetermined destination if said destination is not yet input.

15. The recording medium according to claim 14, further causing the program to execute the steps of:
authenticating an input user as a specific user according to input of predetermined data; and
obtaining address data including the predetermined destination associated with the authenticated input user.

16. The recording medium according to claim 15,
wherein in said step of obtaining, read setting information associated with said input user for defining an operation performed by said image reader is further obtained.

17. The recording medium according to claim 14, further causing the program to execute the step of:
displaying the input destination,
wherein a situation that the destination is not yet input during said predetermined mode at the time of said operation of said predetermined key corresponds to a situation that a display content of said display unit is blank in said step of displaying.

18. The recording medium according to claim 17,
wherein in said step of displaying, said predetermined destination is displayed if said predetermined key is operated.

19. The recording medium according to claim 14,
wherein said predetermined destination is a transfer apparatus connected to the data transmitting apparatus over a network, and
said image data is transmitted to another predetermined destination connected to the data transmitting apparatus via said transfer apparatus over the network.
